(19) United States
(12) Patent Application Publication
(10) Pub. No.: US 2022/0127176 A1
(43) Pub. Date: Apr. 28, 2022

(54) METHOD AND SYSTEM FOR TREATING WASTEWATER

(71) Applicant: ANAERGIA INC., Burlington (CA)

(72) Inventors: Alessandro MASSONE, Milan (IT); Juan Carlos JOSSE, Aliso Viejo, CA (US)

(21) Appl. No.: 17/422,135

(22) PCT Filed: Jan. 14, 2020
(86) PCT No.: PCT/CA2020/050035

§ 371 Date: Jul. 9, 2021

(30) Foreign Application Priority Data
Jan. 14, 2019 (IT) 102019000000577

(51) Int. Cl. C02F 9/00; C02F 11/12; C02F 1/04; C02F 1/24; C02F 1/44; C02F 1/20; C02F 1/66; C02F 1/74; C05F 7/00; C05F 17/60

(52) U.S. Cl. CPC C02F 9/00; C02F 2209/24; C02F 1/04; C02F 1/24; C02F 1/441; C02F 1/20; C02F 1/66; C02F 1/74; C05F 7/00; C05F 17/60; C02F 2209/02; C02F 2209/06; C02F 2209/10; C02F 2209/19; C02F 2209/22; C02F 11/12

(57) ABSTRACT

This specification describes systems and methods for treating wastewater, for example digestate. The wastewater is separated into a liquid fraction and a solid fraction. The solid fraction of the wastewater is composted. The liquid fraction of the wastewater can be treated, which may result in further by-products. Optionally, at least some of the liquid fraction may be reused in the process. The by-products produced in treating the liquid fraction and/or additional organic solid waste, for example green waste, brought into the treatment facility can be added to the compost. The compost breaks down through aerobic and/or anaerobic digestion processes. Thermophilic conditions may develop in composting piles and increase the rate of evaporation of excess water. When sufficiently dry, the compost may be used as a fertilizer or soil enhancement product.

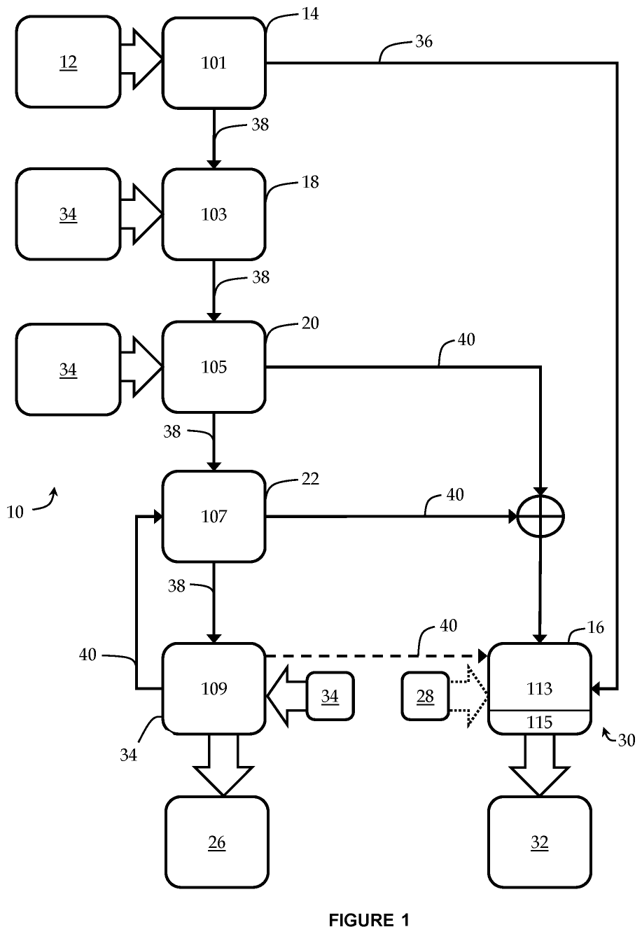

### RELATED APPLICATIONS

This application claims priority to Italian patent application 102019000000577 filed on Jan. 14, 2019, which is incorporated herein by reference.

### FIELD

This specification relates to treating wastewater, for example sludge from an anaerobic digester, and to recovering organic waste, for example as compost.

### BACKGROUND

The treatment of wastewater is a basic undertaking for preventing contamination of the soil and aquifers with pollutant products from human activities. Wastewater can include urban, industrial and/or agricultural drainage materials or other liquid refuse or waste products (referred to as “waste” or “wastewater” for simplicity hereinafter) containing, among other things, organic matter. One form of wastewater is sludge produced from an anaerobic digestion plant. This sludge may be alternatively called “digestate” herein, although in other contexts the word “digestate” is used to refer only to a solid fraction of digester sludge. An anaerobic digester can be used to treat, for example, source separated organics, organic waste separated from municipal waste, food processing or other industrial organic waste, or agricultural waste.

The treatment of wastewater at a high concentration of total ammonia nitrogen (measured herein as combined NH₃—N and NH₄⁺—N), for example over 1000 mg/L, with a high chemical oxygen demand (COD>3000 mg O₂/L), as in the case of digestate obtained as a byproduct from waste processing plants using anaerobic digestion, is a complex and energy-consuming process. Various conventional treatments for removing ammonium and ammonia from waste water, such as nitrification-denitrification, the SHARON method and the Anammox method, have a high electrical energy consumption and/or involve the use of chemical compounds in high amounts and/or specific bacteria that have to be controlled and contained in the treatment environment. These factors make the treatment process of the wastewater rather expensive and complex.

In particular, it is difficult to obtain an efficient process for treating wastewater, in particular in the case of the digestate, which makes it possible to obtain a liquid effluent having stable characteristics that are suitable for discharge into a body of water (generally COD<160 mg O₂/L and NH₃—N+NH₄—N<10 mg/L).

### SUMMARY OF THE INVENTION

This specification describes systems and methods for treating wastewater, for example digestate, which contains organic contaminants. The systems and methods allow for the recovery of an organic fertilizer or soil enhancement product, optionally referred to as “compost”. The wastewater is separated into a liquid fraction and a first solid fraction. The liquid fraction of the wastewater can be treated, which may result in further solids fractions while reducing the volume and contaminant concentration of the remaining liquid fraction. Optionally, at least some of the liquid fraction may be re-used in the process. The further solids fractions produced in treating the liquid fraction and/or additional organic solid waste such as green waste brought into the treatment facility, can be mixed with the first solid fraction of the wastewater. The mixture is composted. The composting process breaks down solids in the mixture, primarily through aerobic digestion processes.

In some examples, thermophilic aerobic digestions conditions develop in the composting mixture, which may be formed into open-air windrows or piles. The thermophilic conditions enhance the evaporation of water thereby decreasing the time required for the composting mixture to reach a solids content, for example 50% TS, suitable for sale or use of the composted product. In examples where additional solid waste, for example green waste (i.e. refuse from gardens or lawns such as grass clippings or leaves, or domestic or industrial kitchen waste), is added to the mixture a treatment facility may receive a tipping fee for receiving the green waste and/or revenue from sale of the compost. In some examples, the system and method recover most, for example 80% or more, of nitrogen (N), phosphorus (P) and potassium (K) originally contained in the wastewater into the composted product.

In some examples, a method of treating wastewater has steps of separating a liquid fraction of the waste from a first solid fraction of the waste, extracting one or more further solid fractions from the liquid fraction of the waste, obtaining a mixture by mixing the first solid fraction of the waste with the one or more further solid fractions extracted from the liquid fraction of the waste, and subjecting the mixture to aerobic composting, thereby obtaining a fertilizing or soil enhancing product. The product may include most, for example 80% or more, of the nitrogen (N), potassium (K) and/or phosphorus (P) originally contained in the wastewater. Optionally, these elements are available in compounds, which may produce a slow-release of the elements when the product is used.

In some examples, a first solid fraction of the wastewater may be separated from the liquid fraction by a thickening and/or dewatering, for example by centrifugation, filtration and/or pressing. The remaining liquid fraction may be subjecting to flotation to obtain a further solid fraction. Optionally, the liquid fraction may be treated, for example by way of aeration or coagulant and/or polymer addition, prior to or during flotation. Aeration may help to manage volatile compounds (for example sulfides) that may form in the system and process. Aeration may also oxidize some of the volatile organic compounds present in the wastewater (or in the liquid fraction thereof). Optionally, the flotation step or the aeration step, or both, includes metering an amount of pure oxygen, carbon dioxide and/or sulfuric acid into the liquid fraction of the waste so as to bring the pH thereof to values of between 5 and 7, more preferably between 5.5 and 6.5.

In some examples, organic solid waste from one or more sources other than the wastewater is added to a first solid fraction of the wastewater. The added organic solid waste can have a solids content of 60% TS or more. The organic solid waste may be green waste, for example refuse from gardens or lawns such as grass clippings or leaves, or domestic or industrial kitchen waste. The added organic solid waste helps to increase the solids content of the mixture, which may help with storage or transportation of the composting mixture or reduce a time required to produce a composted product that is dry enough for use.

In some examples, a step of subjecting a mixture of a first solid fraction of the wastewater with one or more further solid fractions and/or added organic solid waste to composting includes obtaining an initial concentration of dry matter in the mixture greater than or equal to 40% TS, aerating the mixture with an airflow of between 10 and 40 m³ per tonne of mixture per hour, and keeping the temperature of the mixture above 50-55° C. for at least 5 days. In some examples, a composting process includes metering an amount of sulfur, for example colloidal sulfur, into a mixture. The sulfur may improve the quality of the product and/or regulate the pH to reduce stripping of the ammonia nitrogen in air during the composting process.

In some examples, a step of extracting a further solid fraction from the liquid fraction of the wastewater includes subjecting a liquid fraction of the wastewater to evaporation to obtain a concentrate and a distillate. The concentrate includes solids, some of which may be nutrient elements, from the liquid fraction of the waste, which may be added to a composting mixture.

In some examples, extracting a further solid fraction from a liquid fraction of the wastewater includes subjecting the liquid fraction to reverse osmosis or nanofiltration. The liquid fraction may be a distillate extracted from the liquid fraction of the wastewater. A concentrate produced by reverse osmosis or nanofiltration may be returned to an upstream evaporation process or added to a composting mixture. The reverse osmosis or nanofiltration can help increase the amount of solids, including nutrient elements, that are recovered from the wastewater into the composted product. Further, the remaining liquid fraction (permeate) is substantially free of contaminants and pollutants. In some examples, the method includes metering an amount of sulfuric acid less than or equal to 1 L/m³ into a distillate obtained from the step of evaporating the liquid fraction of the wastewater. The sulfuric acid helps to retain ammonia nitrogen contained in the distillate in the concentrate obtained during the step of reverse osmosis. Optionally, the permeate may be re-used in the process, for example for polymer dilution, make up water for an odor control scrubber, or other applications that require high quality water.

Further features of methods and processes described herein, and information enabling the use of the claimed inventions, may be apparent from the following detailed description.

### BRIEF DESCRIPTION OF THE FIGURES

One or more embodiments of the invention will be described hereinafter, for explanatory and non-limiting purposes, with reference to the accompanying FIGURE.

The FIGURE is a schematic diagram of a system and method for treating wastewater.

### DETAILED DESCRIPTION

While the invention admits of various modifications and alternative constructions, an embodiment shown in the FIGURE will be described in detail hereinafter. It should be appreciated, however, that there is no intention of limiting the claimed inventions to the specific illustrated embodiment, but, on the contrary, the claimed inventions include all modifications, alternative constructions and equivalents that fall within the scope of the inventions as defined in the claims.

The use of “for example”, “etc.”, “or else” indicates non-exclusive alternatives, without any limitation, unless stated otherwise. The use of “includes” means “includes, but is not limited to” unless stated otherwise.

The FIGURE shows a system 10 for treating wastewater 12 such as digestate. Wastewater 12 is received into an inlet of a thickening and/or dewatering unit 14. A solids fraction outlet of the thickening and/or dewatering unit 14 is connected to a mixer 16. A liquids fraction of the thickening and/or dewatering unit 14 is connected to an inlet of an aeration tank 18. An outlet of the aeration tank 18 is connected to a dissolved air flotation (DAF) unit 20. A solids fraction (float) outlet of the DAF unit 20 is connected to the mixer 16. A liquid fraction outlet of the DAF unit 20 is connected to an evaporator 22. A solids fraction (concentrate) outlet of the evaporator 22 is connected to the mixer 16. A liquid fraction (distillate) outlet of the evaporator 22 is connected to a reverse osmosis of nanofiltration unit 24. A solids fraction (concentrate or brine) outlet of the reverse osmosis of nanofiltration unit 24 is connected to an inlet of the evaporator 22 or to the mixer 16. A liquid fraction (permeate) outlet of the reverse osmosis of nanofiltration unit 24 puts out the system effluent 26. Optionally, the mixer 16 also has an inlet for solid organic waste 28, which can include green waste. The mixer 16 is part of a composting unit 30. The mixer 16 produces a mixture that is composted in the remainder of the composting unit 30 to produce a product 32. One or more of the aeration tank 18, the DAF unit 20 and the reverse osmosis of nanofiltration unit 24 may have an inlet for reagents 34.

In a process, also described with reference to the FIGURE, wastewater 12 is treated to recover a product 32, for example compost. The wastewater 12 may be sludge from an anaerobic digester, alternatively called digestate. The anaerobic digester may be used to treat, for example, source separated organics, commercial or industrial organic waste, or agricultural waste. Optionally, the anaerobic digester may produce biogas.

The wastewater 12 is initially subjected to a procedure of separating a first solids fraction from a liquid fraction. This process provides a first step (101), which optionally takes place using a thickening and/or dewatering unit such as a centrifuge, belt filter, screw press or similar apparatus, to separate a first solids fraction 36 of the wastewater 12. The first solids fraction 36 may have a solids content of 15%-30% TS. The liquid fraction 38 may continue on to one or more further treatments, for example as described below, to produce further solids fractions 40. In an example of step 101, wastewater 12 is introduced into a centrifuge having a rotation capacity such as to separate a majority, optionally substantially the whole, of the solids of the wastewater, only leaving less than 5 g/L, more preferably less than 1-2 g/L, of solids in suspension in the liquid fraction 38. The liquid fraction 38 of the wastewater is rich in ammonia nitrogen, for example in the form of ammonium (NH₄⁺) and ammonia (NH₃), and potassium (K) dissolved in water, whilst the first solid fraction 36 of the digestate is rich in phosphorus (P) and organic nitrogen.

Optionally, the liquid fraction 38 may be treated further to produce further solid fractions 40 as described below. Creating further solid fractions 40 is particularly useful in locations or in seasons when solid organic waste 28 is not available, or not available in sufficient quantities to produce thermophilic conditions in the mixture that is composted in the composting unit 30.

Optionally, the liquid fraction 38 of the wastewater originating from the preceding step 101 is subjected to an aeration step (103). This process is preferably provided if large amounts of volatile reduced chemical compounds (for example sulfides) are present in the liquid fraction 38 at the end of the preceding step 101. In addition, this aeration step 103 also promotes the oxidation of volatile organic compounds.

The liquid fraction 38 of the wastewater at the output of step 101 or of the optional step 103 is subsequently subjected to a flotation step (105) by dissolution of air or carbon dioxide (CO₂)—particularly if the latter has not already been used in the aeration step 103 and is available, for example from a preceding anaerobic digestion process that produced the waste. In an example, this step 105 is carried out with introduction of the gas (air or CO₂) at a few bars of pressure—typically 4-7 bar or 40-70 kPa or 400-700 kPa—into a portion of the liquid fraction 38 of the wastewater and subsequent expansion of this dissolved gas, which produces the “flotation” of suspended fine solid substances that are still present in the liquid fraction 38 of the waste. As a result, it is possible to separate the liquid fraction 38 of the wastewater from this further solid fraction 40 of the wastewater.

Optionally, the flotation step 105 may replace the aeration step 103 with metering of carbon dioxide and, in addition or alternatively, may provide early addition of sulfuric acid (H₂SO₄) analogously to what is described hereinafter. Other reagents 34, besides air, oxygen, carbon dioxide and sulfuric acid, that may be added to the flotation step 105 include coagulants and polymers, for example acrylamide polymers uses as a coagulation or flocculation aid. The flotation step 105 polishes the liquid fraction 38 produced in step 101 to make the liquid fraction 38 suitable for further separation processes described below.

Optionally, during the aeration step 103 or during the flotation step 105, regulation of the pH of the liquid fraction 38 of the wastewater is provided, in such a way that the pH of the liquid fraction of the wastewater is included within a range of desired values. For example, the pH of the liquid fraction 38 of the wastewater may be changed from typically alkaline values to substantially neutral or acidic values, for example pH values of approximately 5.0-6.5. For this purpose, during the aeration step 103 or during the flotation step 105, metering of an amount of pure oxygen (O₂), metering of an amount of carbon dioxide (CO₂) and/or metering of an amount of sulfuric acid (H₂SO₄) into the liquid fraction 38 of the waste may be provided. For example, the metering of pure oxygen is equal to approximately 5-20% of the COD at the input, whilst the meterings of carbon dioxide and sulfuric acid are proportional to the buffer capacity of the liquid in question (in other words the liquid fraction 38 of the wastewater) and are metered to bring the pH to 5.5-6.0 in the case of carbon dioxide and to 5.0-6.0 in the case of sulfuric acid.

Optionally, in the case of an anaerobic digestion plant provided with a carbon dioxide recovery system—as in the case of a plant provided with a system for refining biogas into biomethane—it is possible to use this carbon dioxide produced during the anaerobic digestion as a reagent 34. Indeed, the use of the carbon dioxide, a by-product of the purification of the biogas, makes it possible to reduce the pH of the liquid fraction 38 to desired values, for example from approximately 8.5 to approximately 5 to 6.5, or 5.5 to 6, by consuming at least some of the buffer capacity of the liquid fraction 38 of the wastewater until equilibrium with the carbon dioxide, and makes it possible to lower the costs of an accelerated oxidation step and/or sulfuric acid (H₂SO₄) addition. Indeed, the carbon dioxide is produced within the plant as a whole, comprising an anaerobic digestion system and a system 10 for treating the digestate.

Subsequently, the liquid fraction 38 of the wastewater is introduced into the evaporator 22 so as to be subjected to an evaporation step (107). For example, the evaporation process takes place between approximately 65 and 85 20 C. under vacuum and with optionally three heat recovery steps (effects). The evaporation step produces a further solid fraction 40, optionally called concentrate, which may be 20% to 40%, or 25% to 30%, of the volume of the liquid fraction 38 received by the evaporator 22. The concentrate includes salts and other high-boiling substances that were in solution or in suspension in the input liquid fraction 38, and separates them from a remaining liquid fraction 38 optionally called distillate.

If the pH of the liquid fraction 38 has been reduced, for example by adding an acid, oxygen or carbon dioxide, before evaporation 107 then the concentrate produced by evaporation may include most of the ammonia nitrogen present in the liquid fraction 38, for example an amount of between 70% and 90% of the total ammonia nitrogen present in the liquid fraction 38 as produced in step 101. The addition of carbon dioxide or acid during the aeration step 103 or the flotation step 105 makes it possible to convert the dissolved ammonia (in the gaseous phase at the process temperatures) and the ammonium (liquid at the process temperatures) into ammonium carbonate (solid at the process temperatures). Alternatively, if the pH is not reduced, most of the ammonia in the liquid fraction 38 will volatilize with the water in the evaporator and end up in the distillate. Optionally, as discussed further below, acid can be added to the distillate to help recover ammonia from the remaining liquid fraction downstream of the evaporation step 107.

In an example, the ratio between concentrate and distillate obtained from the evaporation step 107 is between 1:5 and 1:3. In other words, for 100 m³ of liquid fraction at the input, there will be approximately 20-32 m³ of concentrate and 68-80 m³ of distillate. The Applicant has found that it is possible to carry out the evaporation step according to the present invention with an energy consumption of approximately 0.8 kWh/m³.

The distillate obtained from the evaporation step is then subjected to a nanofiltration or reverse osmosis step (109), preferably a reverse osmosis step. In an example, the distillate passes through one or more reverse osmosis membranes, which make it possible to produce a high-quality permeate as the plant effluent 26. The permeate can be released into the environment or re-used as process water. 80% to 90% of the liquid fraction 38 entering step 109 may be produced as effluent 26. The Applicant has found that it is possible to obtain a permeate characterized by a COD of less than 100 mg O₂/L (COD<100 mg O₂/L), and a concentration of ammonia nitrogen of less than 10 mg/L (NH₃—N+NH₄—N<10 mg/L). The permeate may also be substantially free of other contaminants.

Optionally, it is possible to add one or more reagents 34 to the liquid fraction 38 being treated in the nanofiltration or reverse osmosis step (109). In some examples, a low dose (for example approximately 1 L/m³ or less) of sulfuric acid is added into the distillate sent to the membranes. This makes it possible to keep most of the ammonia nitrogen contained in the liquid fraction 38 (i.e. distillate) treated by the membranes in a further solid fraction 40 (the brine or concentrate) produced by membranes. This further solid fraction 40 can be sent to the mixer 16. Alternatively, the further solid fraction generated in step 109 can be recycled to the evaporator 22. Sulfuric acid in the membrane concentrate will then be delivered to the evaporator 22 to help control pH or inhibit scaling in the evaporator 22. This recycle of membrane concentrate to the evaporator 22 is particularly useful when there has not been a preceding administration of acid in the preceding aeration (103) or flotation (105) steps. Further, a portion of the liquid fraction 38 is subjected iteratively to the steps of evaporation and membrane treatment to help recover more of the available ammonia nitrogen. A further solid fraction 40 (concentrate) drawn out of the evaporator 22 can have a high solids content, for example 8-18% total solids (TS). This further solid fraction 40 is sent to the mixer 13 to be added to the product 32.

In the example shown, the nanofiltration or reverse osmosis step (109) is applied to the liquid (condensed) distillate of the preceding evaporation step, which is substantially free of salts aside from ammonia nitrogen. The membranes are able to operate at low pressures with a high service life as a result of the very low hardness of the distillate subjected to membrane treatment such as reverse osmosis.

In the example shown, all further solid fractions 40 are added, directly or indirectly, to the mixer 16. In the mixer 16, the further solid fractions 40 are mixed with the first solid fraction 36 previously separated from the wastewater 12 in step 101. The first solid fraction 36 and the further solid fractions 40 are then subjected to composting 115 and become part of the composted solid product 32. Alternatively, one or more of the further solid fractions 40 may by-pass the mixer 16 and simply be added to the top of the mixture in the composting unit 30. In this case, the further solid fractions 40 still become part of the composted product 32.

In some examples, the first solid fraction 36 (obtained in step 101) is mixed with organic solid waste 28, for example green waste, which is brought into the system 10. The organic solid waste 28 may have a solids content greater than or equal to 60% TS. The organic solid waste 28 may include for example grass cuttings, clippings, straw, rice bran or a mixture of these or other similar products. When sufficient organic solid waste 28 is provided, an easily composted mixture can be obtained without adding some, or possibly any, of the further solid fractions 40 to the mixture. The mixture may therefore contain the first solid fraction 36 and one or more of (a) organic solid waste 28 and (b) one or more further solid fractions 40. However, it is preferred for at least some organic solid waste 28 to be present in the mixture. Composting 115 with at least some organic solid waste 28 tends to create a mixture with a useful solids contain and promotes thermophilic conditions during composting that help remove water from the compositing mixture.

The mixing step 113 is performed in the mixer 16, which may be one or more than one device. In some examples, organic solid waste 28 is supplied to the mixer 16 by a wheel loader. The first solid fraction 36 and one or more further solid fractions 40 can be sprayed into a hopper of the mixer 16. Optionally, one or more further solid fractions 40 can bypass the mixer 16 and be integrated into the aerobic composting process 115. In some examples of the compositing process 115, piles or windrows of composting mixture discharge a liquid percolate that is collected and sprayed back onto the pile or windrows. Some of the water contained in the percolate evaporates and some trickles into the piles or windrows. One or more further solid fractions 40 can be mixed with the percolated and sprayed with the percolate on the piles or windrows.

This mixture is subjected to a composting step (115) to obtain a composted product 32. The composted product 32 (alternatively called compost) can be used as a fertilizer, topsoil or soil conditioner. The mixture at the input to the composting step 115 preferably has a solids content of 40% TS or more since a more dilute mixture would be difficult to transport and deposit into piles or windrows. Adding solid organic waste 28 to the mixture helps to provide this minimum solids content. Diverting one or more of the further solids fractions 40, for example concentrate from evaporation 107 and/or membrane treatment 109, around the mixer 16, for example to the percolate, also helps to provide this minimum solids content.

During the composting step 115, the heat produced by biological processes typical of composting encourages evaporation of at least part of the residual water contained in the mixture or sprayed on top of the mixture. Further, during the composting step 115, the ammonia nitrogen is converted into slow-release organic nitrogen by chemical reactions that are facilitated by the availability of easily degradable organic matter, such as in the first solid fraction 36 and/or the organic solid waste 28. In an example, the process parameters of the composting step 115 are controlled as follows:
the concentration of dry matter in the mixture transferred to the composting step is not less than 40% TS;
the aeration of the composting mixture, including the mass included in the mixture by way of the first solid fraction 36, any further solid fractions 40 whether they bypass the mixture or not, and any solid organic waste 28, is between 10 and 40 m³ of air per tonne of input mixture per hour, and
the temperature of the compost mixture is kept above 50-55° C. for at least 5 days.

Optionally, the mixing step 113 or the composting step 115 may include adding sulfur, for example colloidal sulfur (S), to the mixture. The added sulfur helps to improve fixing of the ammonia nitrogen. Advantageously, the production of colloidal sulfur can take place naturally in anaerobic digestors in a step of cleaning biogas produced by the digester of hydrogen sulfide. The addition of sulfur helps to regulate the pH of the composting mixture and prevent stripping of the ammonia nitrogen in air, particularly during the initial steps of the aerobic composting process that takes place in the composting step 115. Further, colloidal sulfur is used as a natural fungicide in agriculture and any remaining colloidal sulfur may improve a similar fungicidal effect in the product 32.

The product 32 can be entirely of biological origin, for example derived from organic waste treated in the digester that produces wastewater 12 optionally with added organic solid waste 28. The product 32 contains nitrogen (N), which may be in a slow-release form. The product 32 can also contain most of the phosphorus (P) and potassium (K) contained in the wastewater 12.

In one example, 100 t/d (tonnes per day) of digestate having a solid content of 5-6% TS is treated. The solid/liquid separation step 101 and flotation step 105 separate approximately 20 t/d of solid fraction 36, 40 from approximately 80 t/d of liquid fraction 38. The subsequent steps of evaporation 107 and reverse osmosis 109 produce approximately 16-26 t/d of concentrate and 54-64 t/d of distillate, of which 46-54 t/d are released as purified effluent (permeate) downstream from the reverse osmosis step. At the conclusion of the process according to the present invention, for 100 t of wastewater having approximately 5% TS:
50 m³ of purified water (potentially reusable in the process in whole or in part) and
25-35 t of compost
   are obtained if 20-30 t of organic solid waste 28 is added during the mixing step 113 (case A).

Alternatively, it is possible to obtain:
10 m³ of purified water (optionally reusable in whole or in part in the process), and
40-60 t of compost, if 50-60 t of organic solid waste 28 is added during the mixing step 113 (case B).

The system and process are capable of numerous modifications and variants while remaining within the scope of the present invention as set out in the accompanying claims. For example, but without limitation, the aeration step 103 may be carried out before the solid/liquid separation step 101. In another example, the composting step 115 may be replaced with a drying phase, during which water contained in the first solid fraction 36 of the digestate and in one or more further solid fractions 40 is removed. For example, the first solid fraction 36 of the digestate and one or more further solid fractions 40 may be heated within a predetermined range of temperatures, for example temperatures of between 75 and 80° C. The drying may be carried out using a hot fluid such as air. At the end of the drying phase, a dry final product rich in nitrogen (N), phosphorus (P) and potassium (K) from the wastewater 12 is obtained.

Further, all details may be replaced with other technically equivalent elements. For example, although the above description refers to a digestate by-product of anaerobic digestion, the method and the related system described herein may be used for processing various types of waste, such as industrial wastewater, concentrated civil wastewater (such as the water collected from non-flushing urinals), biological purification sludges, industrial liquid waste having a high nitrogen content, and/or by-products obtained during the treatment processes of this waste.

The materials or equipment used in the system and process, as well as the relevant shapes and dimensions, may be any that are in accordance with the specific implementation requirements without departing from the scope of protection of the following claims.

We claim:

1. A method for treating wastewater, comprising the steps of
separating a first solid fraction of the wastewater from a liquid fraction of the wastewater;
optionally extracting one or more further solid fractions from the liquid fraction of the wastewater;
obtaining a mixture by mixing the first solid fraction of the waste with (a) at least one of the one or more further solid fractions and/or organic solid waste; and,
subjecting the mixture to aerobic composting, thereby obtaining a composted product.

2. The method of claim 1 comprising separating a further solid fraction of the wastewater from the liquid fraction of the wastewater by way of flotation.

3. The method of claim 1 or claim 2, further comprising the step of subjecting to aeration at least one of the wastewater and a liquid fraction of the wastewater.

4. The method of any of claims 1 to 3 comprising adding an amount of pure oxygen (O₂), carbon dioxide (CO₂) and/or an acid such as sulfuric acid (H₂SO₄) into the liquid fraction of the wastewater so as to bring the pH thereof to values of between 5 and 7, optionally between 5.5 and 6.5.

5. The method of any of the preceding claims, wherein the step of obtaining a mixture comprises adding to the mixture an organic waste product such as green waste having a solids content greater than or equal to 60% TS.

6. The method of any of the preceding claims, wherein the step of subjecting the mixture to aerobic composting comprises:
obtaining an initial concentration of dry matter in the mixture greater than or equal to 40% TS;
aerating the mixture with an airflow of between 10 and 40 m³ per ton of mixture per hour, and
keeping the temperature of the mixture above 50-55 ° C. for at least 5 days.

7. The method (100) of any of the preceding claims, wherein one of the step of obtaining a mixture and the step of subjecting the mixture to aerobic composting comprises adding sulfur, for example colloidal sulfur, into the mixture.

8. The method (100) of any of the preceding claims comprising extracting a further solid fraction from the liquid fraction of the wastewater by evaporation to obtain a concentrate and a distillate.

9. The method of claim 8 comprising iterating the steps of:
subjecting the distillate to reverse osmosis to obtain a permeate and a reverse osmosis concentrate, and
subjecting the reverse osmosis concentrate to evaporation.

10. The method of claim 8 or claim 9 comprising a step of adding an amount of sulfuric acid, for example less than or equal to 1 L/m³, into the distillate obtained by evaporation prior to treating the distillate by reverse osmosis.
